(19) United States
(12) Patent Application Publication
(10) Pub. No.: US 2025/0285222 A1
(43) Pub. Date: Sep. 11, 2025

(54) ARTIFICIAL INTELLIGENCE ANIMATION PIPELINE

(71) Applicant: QUALCOMM Incorporated, San Diego, CA (US)

(72) Inventors: Nan ZHANG, Beijing (CN); Zhiguo LI, Beijing (CN); Yongjun XU, Beijing (CN)

(21) Appl. No.: 19/128,952

(22) PCT Filed: Feb. 3, 2023
(86) PCT No.: PCT/CN2023/074331

§ 371 Date: May 9, 2025

(30) Foreign Application Priority Data
Feb. 2, 2023 (WO) PCT/CN2023/074233

(51) Int. Cl. G06T 3/4053; G06T 1/20; G06T 3/4007; G06T 3/4046; G06T 13/80

(52) U.S. Cl. CPC G06T 3/4053; G06T 1/20; G06T 3/4007; G06T 3/4046; G06T 13/80

(57) ABSTRACT

Systems and methods include upscaling images on a display of a computing device (e.g., as part of a zoom operation, etc.) using two image processing pipelines running in parallel. In response to receiving a user zoom input on an image layer, the computing device may render an animation of adjustments in the displayed size of the image layer using image frames generated by a first image processing pipeline that uses an interpolation scaling technique to enlarge image frames of the image layer and image frames generated by a second image processing pipeline that uses a super resolution technique to upscale image frames of the image layer. As upscaled image frames are generated by the second image processing pipeline the upscaled images may be provided to the first image processing pipeline for enlarging using the interpolation scaling technique, yielding smooth animation with less reduction in image details.

### RELATED APPLICATIONS

This application claims the benefit of priority from International Patent Application No. PCT/CN2023/074233, filed 2 Feb. 2023; the entire contents of which is herein incorporated by reference.

### BACKGROUND

Computing devices, such as smartphones, that utilize Artificial Intelligence (AI) for image processing have grown in popularity and use. These devices may include a dedicated AI processor or AI accelerator that is designed to run machine learning algorithms efficiently. The AI processor/accelerator may also run convolutional neural networks (CNNs) as part of a CNN-based AI image processing system. CNNs are a deep learning technique or technology that is well suited for various image processing tasks such as image recognition, object detection, and image segmentation.

In a computing device with a CNN-based AI image processing system, the CNNs may be run on the AI processor or accelerator to analyze and process the images that are displayed on the computing device's electronic screen. The use of AI for image processing may improve the performance and efficiency of the electronic display and graphics, and enhance the user experience by providing improved image quality, real-time image enhancements, and more realistic virtual reality and augmented reality experiences.

### SUMMARY

Various aspects include methods of performing a zoom operation on a computing device, which may include receiving a zoom user input on an image layer within a display on the computing device, and rendering an animation of adjustments in a displayed size of the image layer, responsive to the received zoom user input, using image frames generated by a first image processing pipeline that uses an interpolation scaling technique to enlarge image frames of the image layer and image frames generated by a second image processing pipeline that uses a super resolution technique to upscale image frames of the image layer, in which: the first image processing pipeline and the second image processing pipeline function in parallel, the second image processing pipeline outputs upscaled image frames of the image layer to the first image processing pipeline, and the first image processing pipeline uses the interpolation scaling technique to enlarge image upscaled frames received from the second image processing pipeline.

In some aspects, rendering the animation of adjustments in the displayed size of the image layer responsive to the received zoom user input begins with rendering of image frames generated by the first image processing pipeline based on the image layer until the first image processing pipeline receives an upscaled image frame from the second image processing pipeline, and continues thereafter rendering image frames generated by the first image processing pipeline based on the upscaled image frames received from the second image processing pipeline. In some aspects, the final rendering of the image layer after the zoom user input is complete may be a final upscaled image generated by the second image processing pipeline.

Some aspects may further include determining an upscaling ratio of super resolution image frames to interpolation scaled image frames based on the complexity of the super resolution technique and a power budget of the computing device, or tradeoffs between fast processing and higher quality output, and outputting the upscaled image frames from the second image processing pipeline at a rate compared to a rate at which image frames are generated by the first image processing pipeline based on the determined upscaling ratio.

In some aspects, the interpolation scaling technique may be performed in a graphics processing unit (GPU), and the super resolution technique may be performed in a digital signals processor (DSP) or an artificial intelligence (AI) processor/accelerator. In some aspects, the second image processing pipeline may use an AI convolutional neural network (CNN) super resolution technique to upscale image frames of the image layer. In some aspects, the first image processing pipeline may be a Bilinear-Bicubic pipeline, and the second image processing pipeline may be a convolutional neural network super resolution (CNN SR) pipeline. In some aspects, the Bilinear-Bicubic pipeline may be implemented in a GPU, deep processing unit (DPU), or concurrently on the GPU and DPU, and the CNN SR pipeline may be implemented in the GPU, DSP, central processing unit (CPU), or any combination thereof.

Further aspects may include a computing device having a processor configured with processor-executable instructions to perform various operations corresponding to the methods discussed above.

Further aspects may include a non-transitory processor-readable storage medium having stored thereon processor-executable instructions configured to cause a processor to perform various operations corresponding to the method operations discussed above.

Further aspects may include a computing device having various means for performing functions corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A illustrates image frames produced in a zoom animation according to various embodiments.

FIG. 1B illustrates a zoom animation resulting from the produced image frames illustrated in FIG. 1A.

FIGS. 2A and 2B are component block diagrams illustrating an example software implemented neural network that could benefit from implementing the embodiments.

FIGS. 3A and 3B are component block diagrams illustrating interactions between functionality components in an example convolutional neural network that could be configured to implement some embodiments.

FIG. 4 is a component block diagram illustrating a computing system that could be configured to implement some embodiments.

FIG. 5 is a process flow diagram illustrating a method of generating a zoom animation according to various embodiments.

FIG. 6 is a component block diagram illustrating an example computing device suitable for use with various embodiments.

FIG. 7 is a component block diagram illustrating an example wireless communication device suitable for use with various embodiments.

FIG. 8 illustrates an example wearable computing device in the form of a smart watch suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include methods, and computing devices configured to implement the methods, for performing a zoom operation on a computing device that balances smoothness of the animation with image quality. This balance is accomplished by rendering a zoom animation in response to a zoom user input using image frames generated by a first image processing pipeline that uses an interpolation scaling technique to enlarge image frames of an image layer and using image frames generated by a second image processing pipeline running in parallel that uses a super resolution technique to upscale image frames of the image layer. The first image processing pipeline outputs image frames at a fast enough rate to render a smooth animation. The second image processing pipeline outputs upscaled image frames of the image layer at a slower rate but with higher image quality. As the higher quality image frames are generated by the second image processing pipeline those image frames may be rendered in the animation and provided to the first image processing pipeline for subsequent enlargement for the animation, thus enabling subsequent interpolation scaling to proceed from each higher quality image frame output by the second image processing pipeline.

The term “computing device” may be used herein to refer to any one or all of quantum computing devices, edge devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smartwatch, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processor that can be configured to provide the functionality of various embodiments.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC also may include any number of general purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. SoCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard, in a single UE, or a single CPU device. The proximity of the SoCs facilitates high speed communications and the sharing of memory and resources.

The term “neural network” is used herein to refer to an interconnected group of processing nodes (e.g., neuron models, etc.) that collectively operate as a software application or process that controls a function of a computing device or generates a neural network inference. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and activation. The weight values may be determined during a training phase and iteratively updated as data flows through the neural network.

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers. Each layer in a neural network may have multiple inputs, and thus multiple previous or preceding layers. Said another way, multiple layers may feed into a single layer. For case of reference, some of the embodiments are described with reference to a single input or single preceding layer. However, it should be understood that the operations disclosed and described in this application may be applied to each of multiple inputs to a layer as well as multiple preceding layers.

The term “convolutional neural network” (CNN) may be used herein to refer to a deep neural network in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations generate the overall inference result of the neural network, such as a probability that an image contains a specific object (e.g., a person, cat, watch, edge, etc.) or information indicating that a proposed action should be taken.

The term “inference” may be used herein to refer to a process that is performed at runtime or during execution of the software application program corresponding to the neural network. Inference may include traversing the processing nodes in the neural network along a forward path to produce one or more values as an overall activation or overall “inference result.”

A computing device may include a display and graphics hardware or subsystem that utilizes Artificial Intelligence (AI) to enhance the performance and capabilities of the display and graphics processing. In a computing device that utilizes AI for image processing, the hardware may include a dedicated AI processor or an AI accelerator that is designed to run machine learning algorithms more efficiently than the other processors. CNNs are one of the most commonly used machine learning algorithms for image processing.

In a computing device with a CNN-based AI image processing system, the CNNs may be run on the AI processor or accelerator to analyze and process images that are to be displayed on the computing device's screen. Using AI image processing systems may improve the performance and efficiency of the computing device's display and graphics. AI image processing systems may also enhance a user's experience by supporting features such as improved image quality, real-time image enhancement, and more realistic virtual reality and augmented reality experiences. For example, an AI image processing systems may be used to enhance the realism of virtual and augmented reality experiences by improving the 3D graphics rendering and object tracking.

Bilinear and bicubic scalars are interpolation scaling techniques that may be used to resize or scale images. For example, bilinear or bicubic scalars may be used to change the size of an image by either increasing or decreasing the number of pixels it contains. Bilinear scaling may include using linear interpolation to determine the value of new pixels based on the values of nearby pixels in the original image. Bilinear scaling is particularly useful when the original image is smooth and doesn't contain many fine details. Bilinear scaling may cause loss of detail and blurring when applied to images with high levels of detail or texture. Bicubic scaling is a more complex technique that uses cubic interpolation to determine the values of new pixels based on the values of nearby pixels in the original image. Bicubic scaling may produce better results than bilinear scaling, particularly when scaling up images, with a wide range of image types, including those with high levels of detail or texture. Bicubic scaling may be slower or more processor intensive than bilinear scaling. Both bilinear and bicubic scaling techniques may be used for image zooming and upscaling.

AI super resolution is a technique that may be used to increase the resolution of an image or video. AI super resolution is commonly used in image and video processing tasks to improve the visual quality of the image or video. AI super resolution may be implemented by CNNs that take a low-resolution image as input and generate a high-resolution version of the image as output. AI super resolution may be used to enhance the visual quality of an image and/or video, and may be used for image zooming and upscaling. AI super resolution may be slower than bilincar and bicubic scaling, but generally produces a much higher image quality.

In recent years, AI display/graphics chipsets that utilize convolutional neural network (CNN) based image processing have grown in popularly. Yet, despite their potential in terms of power, performance and flexibility, these AI display/graphics chipsets are still not widely deployed or sued in mobile computing devices. Concurrent with these trends, device manufacturers have begun developing end-user-aware AI display/graphics solutions. Some embodiments may utilize AI display/graphics chipsets to implement an end-user-aware AI display/graphics solution that includes run-time zoom and magnification.

End-user-aware AI display and graphics solutions are systems that use AI to adapt the performance and capabilities of the display and graphics system to the needs and preferences of the end user. In an end-user-aware system, the AI algorithms may analyze data about the user's usage patterns, preferences and environment, and use this information to optimize the performance and capabilities of the display and graphics system. End-user-aware AI display and graphics solutions may also improve the overall user experience by providing a more personalized and optimized display and graphics system that is tailored to the needs and preferences of the individual user.

Conventional computing devices do not include support for run-time zoom and magnification operations, which may be a significant issue for end users and devices. For example, while some map applications and web browsers offer the ability to zoom in on specific content, the majority of applications (e.g., browsers) do not support such features or functionality. In addition, applications and device operating systems do not offer run-time zoom or magnification as a part of their user interface theme. This lack of support for “anytime, anywhere” zoom may be frustrating for end users, who may find themselves unable to clearly see the contents of a picture or text on their computing devices (e.g., smartphones, etc.). In some cases, users may be able to search for and zoom in on specific content by clicking a link repeatedly. Even when any of the above options are available, these processes for zooming and magnification are inefficient, ineffective, time-consuming and/or inconvenient. All these factors may have a negative impact on the user experience.

Current operating systems, devices, and applications do not provide run-time zoom due to various technical challenges. Providing such features could require a significant amount of effort to redesign and rework the user interface (UI) or content layout design and rendering engine to support a wide range of devices with different display contexts. Zooming in on application image layers or graphics content directly in the rendering process may present complex technical challenges and/or require significant resources to implement. There are various technical challenges associated with maintaining visual quality and performance/power during upscaling or magnification.

While conventional image scaling techniques such as bilinear and bicubic interpolation may not provide sufficient detail, AI-based super resolution techniques are often too resource-intensive for use on battery powered computing devices (e.g., smartphones and similar mobile devices), leading to issues with battery life and smoothness.

Various embodiments overcome these limitations of conventional graphics systems in current computing devices to improve run-time zoom and magnification functionalities, and thereby improve the user experience. Various embodiments accomplish this by implementing dual parallel-running scalar processing pipelines to render upscaled/zoomed images that are a hybrid of resizing using conventional interpolation scaling techniques and upscaling using super resolution techniques to provide seamless zooming animations for the end user. In various embodiments a first pipeline uses conventional interpolation scaling techniques, such as bilinear-bicubic scalars, to generate scaled image frames with real time processing while a second pipeline uses super resolution CNN upscaling to output image frames with greater resolution (less detail loss) at a slower rate. The super resolution image frames are provided to the first pipeline for subsequent interpolation scaling, as well as for display, thereby enabling the zoom animation to proceed with reduced loss of image details that happen using convention scalar techniques alone.

In some embodiments, a computing device may be configured to implement run-time zoom and magnification functionalities by receiving a low-resolution frame (e.g., from an application operating on the mobile computing device), using a conventional interpolation scaling technique (e.g., Bilinear scaling, Bicubic scaling, etc.) to process the low-resolution frame in a first image processing pipeline to produce a sequence of magnified images, and using an AI CNN super resolution technique to process the low-resolution frame in a second image processing pipeline that operates in parallel with the conventional interpolation scaling technique to periodically produced upscaled image frames. When an output from the AI CNN super resolution technique is available (e.g., output from the second image processing pipeline), the computing device may provide that upscaled image frame to the first pipeline for magnification in subsequent image frames using the conventional interpolation scaling techniques. The computing device may display the upscaled frames (e.g., in response to a user zoom gesture on application layer associated with the application operating on the computing device) on its electronic display as a zoom animation ending in a magnified image of the initial low-resolution frame. By periodically substituting into the first pipeline the upscaled image frames produced by the second pipelines AI CNN super resolution technique, a continuous zoom animation can be produced that minimizes the loss in visual detail that results from conventional interpolation scaling techniques while providing zooming image frames at a sufficient frequency to yield a smooth animation.

In some embodiments, the computing device may be configured to upscale the output from the super resolution technique using the conventional interpolation scaling technique based on an upscaling ratio of super resolution to interpolation scaling. This ratio may reflect how much each super resolution image frame is scaled up using conventional interpolation scaling. In some embodiments, the computing device may determine the upscaling ratio based on the complexity of the super resolution technique and the power budget of the system as AI CNN super resolution techniques process more information and thus consume more power than conventional interpolation scaling techniques. In some embodiments, the computing device may determine the upscaling ratio so as to balance tradeoffs between fast processing and higher quality output.

The computing device can scale up low-resolution frames faster using the conventional interpolation scaling techniques in the first pipeline than the computing device can process low-resolution frames using the super resolution technique. However, using the super resolution technique in the second pipeline to process the low-resolution frame allows the computing device to produce upscaled images with more image details and resolution than possible using the conventional interpolation scaling techniques. By operating both pipelines in parallel and using the higher resolution image frames from the second (i.e., super resolution) pipeline to periodically (e.g., according to an upscaling ratio) provide a super resolution image frame to the first pipeline for subsequent upscaling using conventional interpolation scaling techniques, the computing device may efficiently balance tradeoffs between power consumption, performance (e.g., frame rate) and resulting image quality, particularly a smooth animation with less reduction in image details.

Various embodiments improve the user experience of users performing a zoom operation on an image element on a computing device by providing smoother animations of the zoom without a reduction in image details. In particular, the more frequent image frames provided by the first pipeline implementing conventional interpolation scaling techniques enables smooth animation (i.e., no flickering or sudden shifts) while the higher resolution and greater visual details in the image frames provided by the pipeline implementing super resolution techniques reduces loss of details and visual quality as the animation progresses as well as in the final zoomed image when the animation concludes (e.g., when the user's zoom input ends).

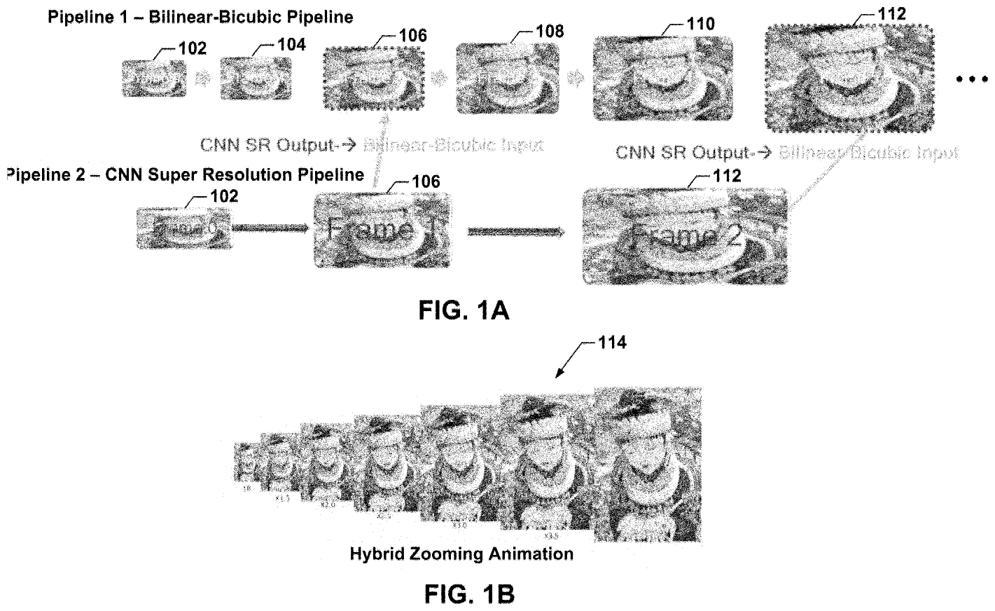

FIG. 1A illustrates the processes of various embodiments to produce a zoom animation that is illustrated in FIG. 1B. The process of generating a zoom animation may begin with the user selecting an image layer or object in a display, such as a thumbnail image from an application, and inputting a zoom user input, such as touching a touch-sensitive display with two fingers and moving the finger tips apart. In response to such a user input, the computing device may select or obtain a starting image frame 102 as frame 0 that is provided to both pipeline 1 (e.g., a bilincar-bicubic pipeline) and pipeline 2 (e.g., a CNN super resolution pipeline).

The two pipelines may begin rendering enlarged versions of the starting image frame 102, which may also be rendered as the first frame in a zoom animation 114. First to output an image frame 104 (frame 1) is pipeline 1 using its faster interpolation enlarging technique. This image frame 104 may be output to the display as a frame in the zoom animation 114. Pipeline 1 may continue to output enlarged image frames (not shown) that are displayed in the zoom animation until pipeline 2 produces an upscaled image frame 106. When this happens, the upscaled image frame 106 may be provided to pipeline 1 for use in generating subsequent enlarged image frames and also rendered as part of the zoom animation 114. Pipeline 1 receives the upscaled image frame 106 as an input and enlarges that image to generate the next image frame 108 that is output to the display as a frame in the zoom animation 114. Image frame 108 is an enlarged version (enlarged using convention interpolation scaling techniques) of the upscaled image frame 106 (i.e., enlarged after upscaling). Pipeline 1 may enlarge that same image frame 106 further using conventional interpolation scaling techniques to generate the next image frame 110 that is rendered as part of the zoom animation 114. Thus, image frames 108 and 110 are a hybrid of an upscaled produced using super resolution techniques that have been enlarged using convention scalar techniques. Again, pipeline 1 may continue to output enlarged image frames (not shown) that are displayed in the zoom animation 114 until pipeline 2 produces another upscaled image frame 112, which is provided to pipeline 1 for enlarging and rendered as part of the zoom animation 114. Subsequent image frame(s) produced by pipeline 1 would then be enlarged versions of the upscaled image frame 112.

This process of periodically updating the image frame being enlarged using conventional interpolation scaling techniques of pipeline 1 with upscaled image frames produced by the super resolution techniques of pipeline 2 until the zoom animation is complete and the final size of the image is rendered, which may be an image frame produced by the super resolution techniques of pipeline 2. Thus, the resulting zoom animation 114 includes many frames produced at a high frequency to provide a smooth animation with the image resolution periodically upscaled so that the animation and the final image do not suffer from a loss of detail typical of conventional interpolation scaling enlargement techniques.

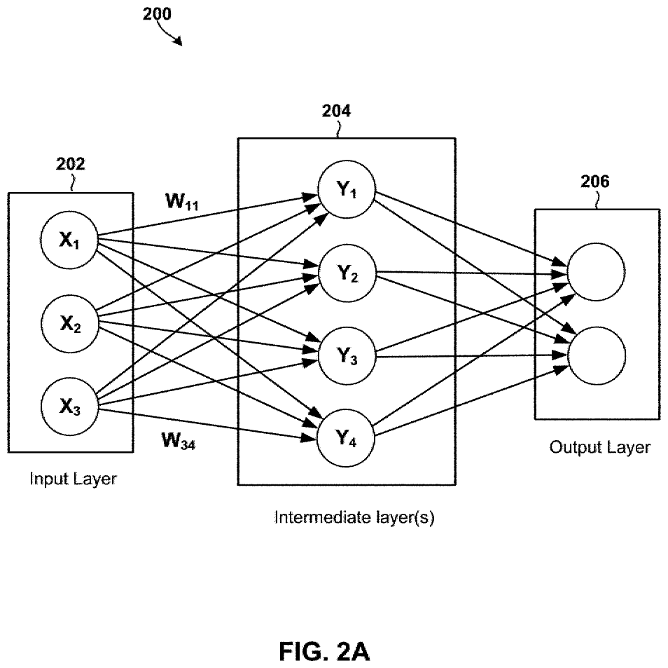

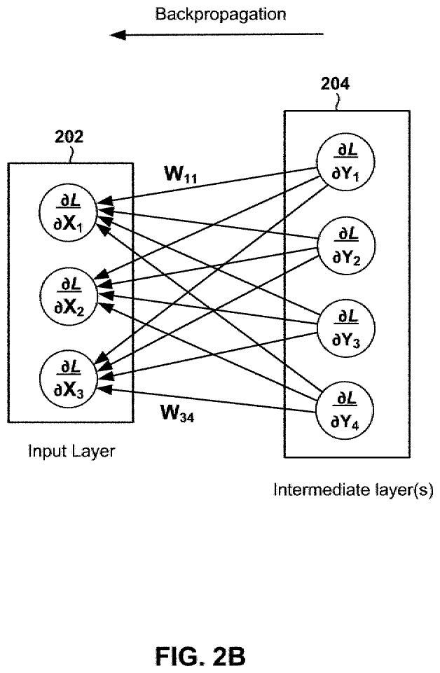

FIGS. 2A and 2B illustrate an example neural network 200 that could be implemented in a computing device, and which could benefit from implementing the embodiments. With reference to FIG. 2A, the neural network 200 may include an input layer 202, intermediate layer(s) 204, and an output layer 206. Each of the layers 202, 204, 206 may include one or more processing nodes that receive input values, perform computations based the input values, and propagate the result (activation) to the next layer.

In feed-forward neural networks, such as the neural network 200 illustrated in FIG. 2A, all of the computations are performed as a sequence of operations on the outputs of a previous layer. The final set of operations generate the output of the neural network, such as a probability that an image contains a specific item (e.g., dog, cat, etc.) or information indicating that a proposed action should be taken. The final output of the neural network may correspond to a task that the neural network 200 may be performing, such as determining whether an image contains a specific item (e.g., dog, cat, etc.). Many neural networks 200 are stateless. The output for an input is always the same irrespective of the sequence of inputs previously processed by the neural network 200.

The neural network 200 illustrated in FIG. 2A includes fully-connected (FC) layers, which are also sometimes referred to as multi-layer perceptrons (MLPs). In a fully-connected layer, all outputs are connected to all inputs. Each processing node's activation is computed as a weighted sum of all the inputs received from the previous layer.

An example computation performed by the processing nodes and/or neural network 200 may be:

$${y}_{i} = f ( {\sum }_{i = 1}^{3} {W}_{ij} * {x}_{i} + b )$$

in which Wᵢⱼ are weights, xᵢ is the input to the layer, yⱼ is the output activation of the layer, f(•) is a non-linear function, and b is bias, which may vary with each node (e.g., bⱼ). As another example, the neural network 200 may be configured to receive pixels of an image (i.e., input values) in the first layer, and generate outputs indicating the presence of different low-level features (e.g., lines, edges, etc.) in the image. At a subsequent layer, these features may be combined to indicate the likely presence of higher-level features. For example, in training of a neural network for image upscaling, the output layer may generate a probability value that various lines, edges, colors, etc. are present in an enlarged (i.e., upscaled) version of the input image. In this manner the neural network can use the information available in a low-resolution small image to predict elements of the image that should be added to fill in details between pixels as the image is enlarged.

A neural network 200 may be trained to upscale images using a database of images of different sizes and resolutions. In this training process a small image may be provided as the input and a larger, higher resolution image of the same subject matter may be provides as the expected/desired output. Learning is accomplished by comparing the output generated by the neural network 200 to the expected/desired output and adjusting weights. The difference between the expected/desired output and the output generated by the neural network 200 is referred to as loss (L). The weights and biases in the neural network are then adjusted to bring the output image closer to the provided expected output image, thereby reducing the loss. During training, the weights (Wᵢⱼ) may be updated using a hill-climbing optimization process called “gradient descent.” This gradient indicates how the weights should change in order to reduce loss (L). A multiple of the gradient of the loss relative to each weight, which may be the partial derivative of the loss

$$( e . g , \frac{\partial L}{\partial X 1} , \frac{\partial L}{\partial X 2} , \frac{\partial L}{\partial X 3} )$$

with respect to the weight, could be used to update the weights and biases. This learning process may be repeated for a large database of images.

An efficient way to compute the partial derivatives of the gradient is through a process called backpropagation, an example of which is illustrated in FIG. 2B. With reference to FIGS. 2A and 2B, backpropagation may operate by passing values backwards through the network to compute how the loss is affected by each weight. The backpropagation computations may be similar to the computations used when traversing the neural network 200 in the forward direction (i.e., during inference). To improve performance, the loss (L) from multiple sets of input data (“a batch”) may be collected and used in a single pass of updating the weights. Many passes may be required to train the neural network 200 with weights suitable for use during inference (e.g., at runtime or during execution of a software application program).

The overall structure of the neural network 200, and operations of the processing nodes, do not change as the neural network learns this task. After such training is completed, the neural network 200 may process any image for upscaling using the determined weights and bias.

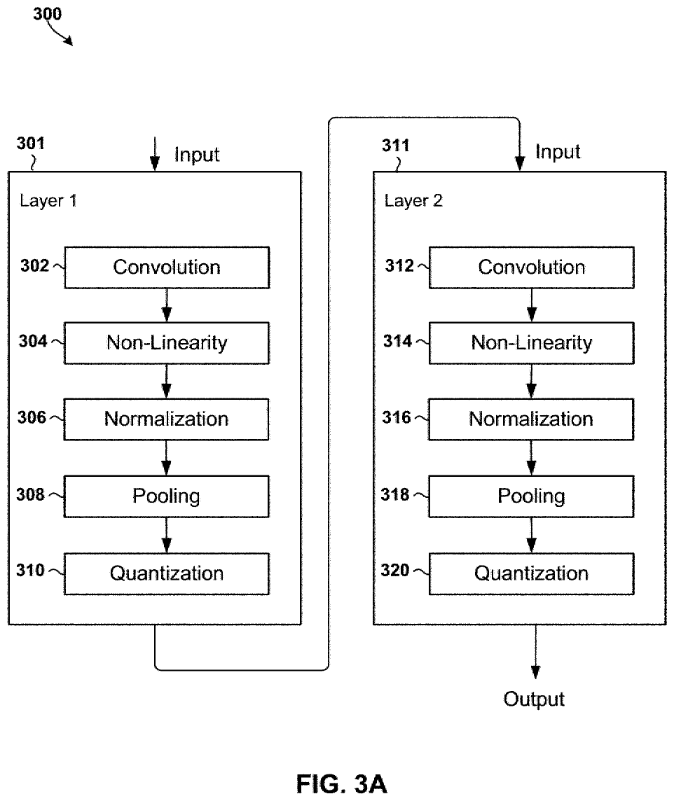

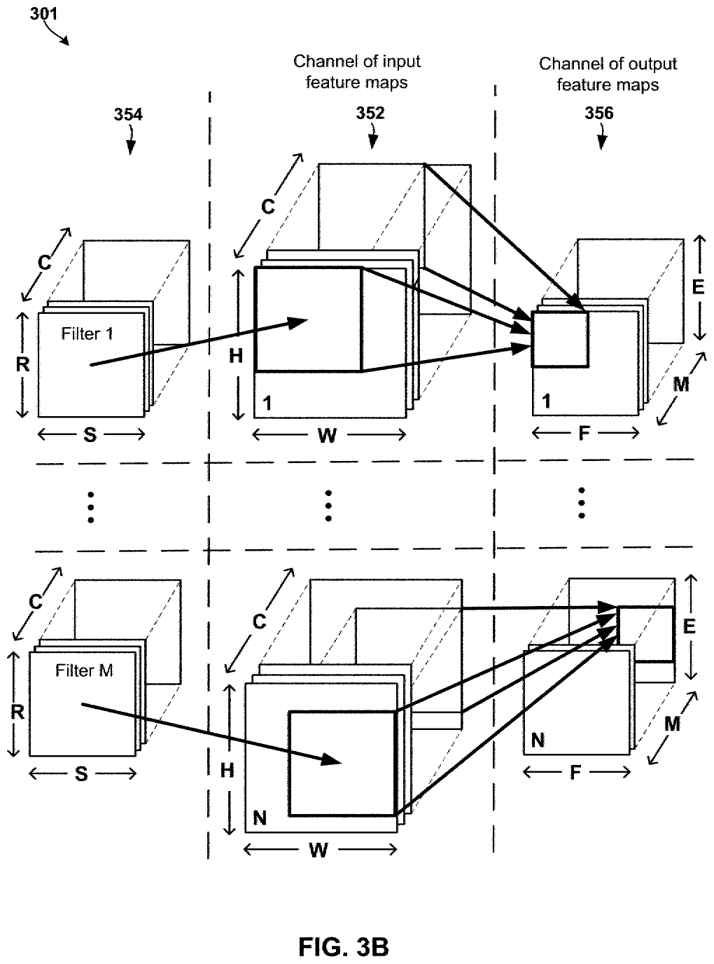

FIGS. 3A and 3B illustrate example functionality components that may be included in a convolutional neural network 300, which could be implemented in a computing device and configured to implement a generalized framework to accomplish continual learning in accordance with various embodiments.

With reference to FIGS. 1A-3A, the convolutional neural network 300 may include a first layer 301 and a second layer 311. Each layer 301, 311 may include one or more activation functions. In the example illustrated in FIG. 3A, each layer 301, 311 includes convolution functionality component 302, 312, a non-linearity functionality component 304, 314, a normalization functionality component 306, 316, a pooling functionality component 308, 318, and a quantization functionality component 310, 320. It should be understood that, in various embodiments, the functionality components 302-310 or 312-320 may be implemented as part of a neural network layer, or outside the neural network layer. It should also be understood that the illustrated order of operations in FIG. 3A is merely an example and not intended to limit various embodiments to any given operation order. In various embodiments, the order and/or inclusion of the operations of functionality components 302-310 or 312-320 may change in any given layer. For example, normalization operations by the normalization functionality component 306, 316 may come after convolution by the convolution functionality component 302, 312 and before non-linearity operations by the non-linearity functionality component 304, 314.

The convolution functionality component 302, 312 may be an activation function for its respective layer 301, 311. The convolution functionality component 302, 312 may be configured to generate a matrix of output activations called a feature map. The feature maps generated in each successive layer 301, 311 typically include values that represent successively higher-level abstractions of input data (e.g., line, shape, object, etc.).

The non-linearity functionality component 304, 314 may be configured to introduce nonlinearity into the output activation of its layer 301, 311. In various embodiments, this may be accomplished via a sigmoid function, a hyperbolic tangent function, a rectified linear unit (ReLU), a leaky ReLU, a parametric RcLU, an exponential LU function, a maxout function, swish, etc.

The normalization functionality component 306, 316 may be configured to control the input distribution across layers to speed up training and the improved accuracy of the outputs or activations. For example, the distribution of the inputs may be normalized to have a zero mean and a unit standard deviation. The normalization function may also use batch normalization (BN) techniques to further scale and shift the values for improved performance.

The pooling functionality components 308, 318 may be configured to reduce the dimensionality of a feature map generated by the convolution functionality component 302, 312 and/or otherwise allow the convolutional neural network 300 to resist small shifts and distortions in values.

With reference to FIGS. 2A-3B, in some embodiments, the inputs to the first layer 301 may be structured as a set of three-dimensional input feature maps 352 that form a channel of input feature maps. In the example illustrated in FIG. 3B, the neural network has a batch size of N three-dimensional feature maps 352 with height H and width W each having C number of channels of input feature maps (illustrated as two-dimensional maps in C channels), and M three-dimensional filters 354 including C filters for each channel (also illustrated as two-dimensional filters for C channels). Applying the 1 to M filters 354 to the 1 to N three-dimensional feature maps 352 results in N output feature maps 356 that include M channels of width F and height E. As illustrated, each channel may be convolved with a three-dimensional filter 354. The results of these convolutions may be summed across all the channels to generate the output activations of the first layer 301 in the form of a channel of output feature maps 356. Additional three-dimensional filters may be applied to the input feature maps 352 to create additional output channels, and multiple input feature maps 352 may be processed together as a batch to improve the reuse of the filter weights. The results of the output channel (e.g., set of output feature maps 356) may be fed to the second layer 311 in the convolutional neural network 300 for further processing.

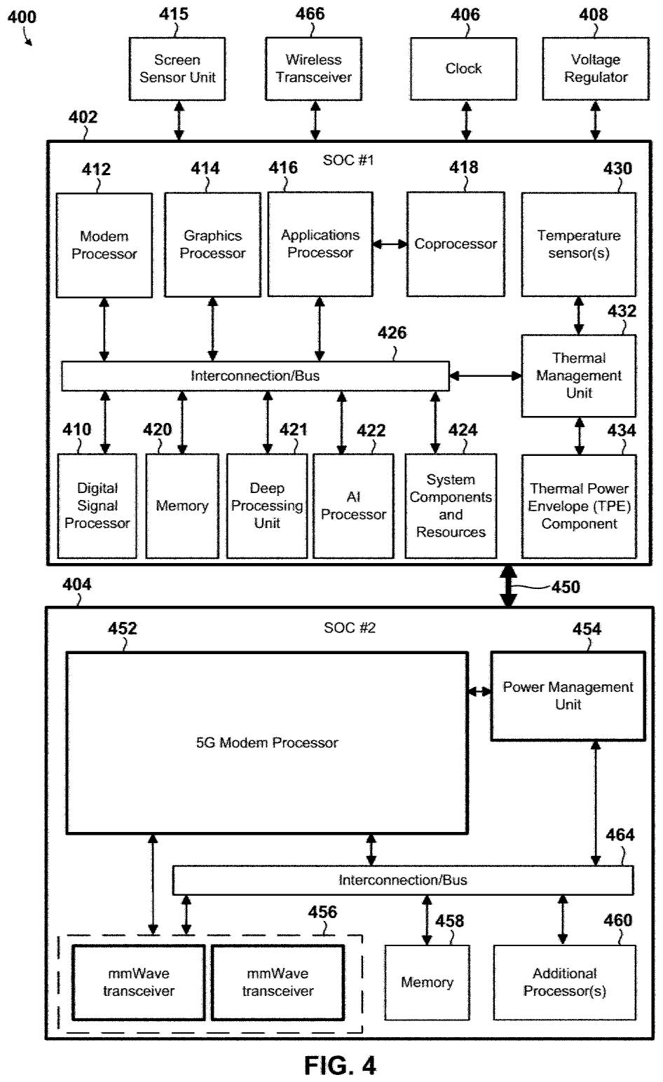

Various embodiments may be implemented on a number of single processor and multiprocessor computer systems, including a system-on-chip (SOC) or system in a package (SIP). FIG. 4 illustrates an example computing system or SIP 400 architecture that may be used in UE devices implementing various embodiments.

With reference to FIGS. 1-4, the illustrated example SIP 400 includes a two SOCs 402, 404, a clock 406, and a voltage regulator 408. In some embodiments, the first SOC 402 operate as central processing unit (CPU) of the UE device that carries out the instructions of software application programs by performing the arithmetic, logical, control and input/output (I/O) operations specified by the instructions. In some embodiments, the second SOC 404 may operate as a specialized processing unit. For example, the second SOC 404 may operate as a specialized 5G processing unit responsible for managing high volume, high speed (e.g., 5 Gbps, etc.), and/or very high frequency short wavelength (e.g., 28 GHz mm Wave spectrum, etc.) communications.

The first SOC 402 may include a digital signal processor (DSP) 410, a modem processor 412, a graphics processor 414, an application processor 416, one or more coprocessors 418 (e.g., vector co-processor) connected to one or more of the processors, memory 420, deep processing unit (DPU) 421, AI processor 422, system components and resources 424, an interconnection/bus module 426, one or more temperature sensors 430, a thermal management unit 432, and a thermal power envelope (TPE) component 434. The second SOC 404 may include a 5G modem processor 452, a power management unit 454, an interconnection/bus module 464, a plurality of mm Wave transceivers 456, memory 458, and various additional processors 460, such as an applications processor, packet processor, etc.

Each processor 410, 412, 414, 416, 418, 421, 422, 452, 460 may include one or more cores, and each processor/core may perform operations independent of the other processors/cores. For example, the first SOC 402 may include a processor that executes a first type of operating system (e.g., FreeBSD, LINUX, OS X, etc.) and a processor that executes a second type of operating system (e.g., MICROSOFT WINDOWS 10). In addition, any or all of the processors 410, 412, 414, 416, 418, 421, 422, 452, 460 may be included as part of a processor cluster architecture (e.g., a synchronous processor cluster architecture, an asynchronous or heterogeneous processor cluster architecture, etc.).

The first and second SOC 402, 404 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 424 of the first SOC 402 may include power amplifiers, voltage regulators, oscillators, phase-locked loops, peripheral bridges, data controllers, memory controllers, system controllers, Access ports, timers, and other similar components used to support the processors and software clients running on a UE device. The system components and resources 424 may also include circuitry to interface with peripheral devices, such as cameras, electronic displays, wireless communication devices, external memory chips, etc.

The first and second SOC 402, 404 may communicate via interconnection/bus module 450. The various processors 410, 412, 414, 416, 418, may be interconnected to one or more memory elements 420, system components and resources 424 and a thermal management unit 432 via an interconnection/bus module 426. Similarly, the processor 452 may be interconnected to the power management unit 454, the mmWave transceivers 456, memory 458, and various additional processors 460 via the interconnection/bus module 464. The interconnection/bus module 426, 450, 464 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 402, 404 may further include an input/output module (not illustrated) for communicating with resources external to the SOC, such as a clock 406, a voltage regulator 408, screen sensor unit 415 and a wireless transceiver 466 (e.g., cellular wireless transceiver, Bluetooth transceiver, etc.). Resources external to the SOC (e.g., clock 406, voltage regulator 408, screen sensor unit 415, wireless transceiver 466) may be shared by two or more of the internal SOC processors/cores.

In some embodiments, any or all of the processors 410, 412, 414, 416, 418, 421, 422, 452, 460 may implement a CNN-based AI image processing system, a Bilincar-Bicubic image processing pipeline and/or a convolutional neural network super resolution (CNN SR) image processing pipeline. For example, in some embodiments, the GPU 414 and/or DPU 421 may implement a Bilinear-Bicubic pipeline and/or AI processor 422, GPU 414, and/or DSP 410 may implement a CNN SR pipeline.

In some embodiments, any or all of the processors 410, 412, 414, 416, 418, 421, 422, 452, 460 may be configured to work in conjunction with the screen sensor unit 415 to perform a zoom operation on a display of a computing device in accordance with the embodiments. For example, the screen sensor unit 415 may monitor end user's touch gestures to conditionally trigger a layer dynamic seamless zoom and corresponding sequential up-scaling animation frames in continuous varying up-scale step factors (1.0--1.01--1.02--1.03-----xxXXX ---------1.99, 2.00, 2.01-----xxxxx-----3.0). The screen sensor unit 415 may detect a zoom user input on an image layer within the display presented on an electronic display of the computing device, and send the information to the GPU 414 and AI processor 422. The GPU 414 may receive the zoom user input, and use an interpolation scaling technique in a first image processing pipeline to adjust a displayed size of the image layer. In parallel, the AI processor 422 may use a super resolution technique in a second image processing pipeline to adjust the displayed size of the image layer. The AI processor 422, GPU 414 and/or another processor (e.g., applications processor 416) may upscale an output of the interpolation scaling technique on the first image processing pipeline with an output from the super resolution technique on the second image processing pipeline to generate an upscaled frame of the image layer, and cause an electronic display of a computing device to display the upscaled frame of the image layer.

In addition to the example SIP 400 discussed above, various embodiments may be implemented in a wide variety of computing systems, which may include a single processor, multiple processors, multicore processors, or any combination thereof.

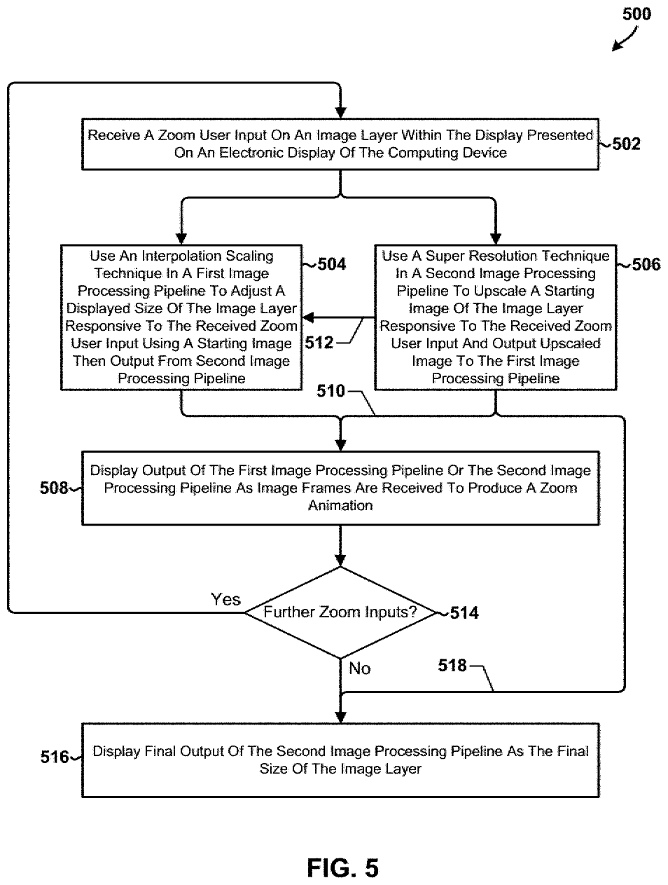

FIG. 5 illustrates a method 500 of performing a zoom operation on a display of a computing device in accordance with various embodiments. Method 500 may be performed by one or more processors (e.g., processors 410, 412, 414, 416, 418, 421, 422, 452, 460 illustrated in FIG. 4) in a computing device.

With reference to FIGS. 1-5, in block 502, the computing device may receive a zoom user input on an image layer within the display presented on an electronic display of the computing device. For example, the computing device may monitor the touch gestures of a user for input indicating that the user wants to change the size of an image (i.e., zoom in or magnify). As another example, the computing device may display a zoom slide bar and receive a user zoom input as a mouse drag of the slide bar from one magnification level to another. The computing device may use this input to trigger a dynamic seamless zoom on a specific image layer in animation of enlarging image frames. In some embodiments, the zoom user input may include or be translated into a continuous varying up-scale step factors (e.g., increments by which the image is to be scaled).

In block 504, the computing device may use an interpolation scaling technique executing in a first image processing pipeline (e.g., pipeline A) to generate image frames of adjusted display size of the image layer (e.g., by using surrounding pixels to estimate the position and color of new pixels as the image frame enlarges) responsive to the received zoom user input. For example, as the user zoom input is received (e.g., as the user's fingers move apart on the display), the first image processing pipeline may incrementally enlarge the image frame, such as from 540×1400 to 567×1470, and then to 594×1540, etc. In some embodiments, this may be accomplished by interspersing pixels in the x and y directions using interpolation to determine the color of each added pixel. In some embodiments, the first image processing pipeline adjusting the image frame size in block may be a Bilinear-Bicubic pipeline. In some embodiments, the interpolation scaling technique may be performed in a graphics processing unit (GPU), deep processing unit (DPU), or a combination thereof. In some embodiments, the first image processing pipeline may be a Bilincar-Bicubic pipeline that is included in GPU, DPU, or concurrently on the GPU and DPU.

The first image processing pipeline (e.g., pipeline A) may rapidly generate image frames of increasing size so that displaying the image frames in block 508 (described below) provides a near real-time seamless zooming animation. Rapid generation of enlarging frames may be accomplished on a GPU or DPU by utilizing a Bilincar-Bicubic scalar techniques.

In block 506, the computing device may use a super resolution technique in a second image processing pipeline (e.g., pipeline B) to upscale the image layer responsive to the received zoom user input and in parallel with the image zoom operations being performed in the first image processing pipeline in block 504. That is, the layer image may be processed in both pipeline A and B in parallel.

In some embodiments, the computing device may be configured to perform the super resolution technique in a digital signals processor (DSP) or an artificial intelligence (AI) processor/accelerator. In some embodiments, the second image processing pipeline may be an AI convolutional neural network super resolution (CNN SR) pipeline and/or the computing device may use an AI CNN SR technique to process the image layer in the second image processing pipeline in block 506. In some embodiments, the second image processing pipeline may be a CNN SR pipeline that is included in the GPU, a digital signals processor (DSP), a central processing unit (CPU), or a combination thereof. In some embodiments, in block 506 and pipeline B, the layer Image may be sent to a CNN SR scalar to generate milestone/target upscaling. In some embodiments, the CNN SR networks may receive target scale factors (e.g., original image size of 540×1400, final image size of 1080×2800) as input parameters.

Using super resolution techniques in the second image processing pipeline enables image frames may be enlarged without losing some of the image details that occur in conventional interpolation magnification techniques used in the second image processing pipeline. However, the super resolution techniques require more processing, and thus cannot be generated as quickly as possible in the first image processing pipeline. Therefore, to enable image frames produced by the second image processing pipeline to be used in the zoom animation, the incremental increase in image size of each image frame generated in the second image processing pipeline will be larger than the incremental increase in image size produced by the first image processing pipeline.

In some embodiments, the computing device may output the upscaled image frames from the second image processing pipeline at a rate compared to a rate at which image frames are generated by the first image processing pipeline based on the determined upscaling ratio. That is, the rate of image frames generated by the second image processing pipeline (i.e., super resolution images) compared to the rate at which image frames are generated by the first image processing pipeline (i.e., interpolation frames) may be defined as an “upscaling ratio” of super resolution image frames to interpolation scaled image frames. The computing device may set the upscaling ratio based on various considerations, including the complexity of the super resolution technique employed in the second image processing pipeline, the processing capabilities of both pipelines, the power consumption (or a power budget) of the second image processing pipeline, and/or tradeoffs between fast processing of the zoom animation and image quality. In some embodiments, the second image processing pipeline may generate super resolution image frames at a rate set by the upscaling ratio such that as each super resolution image frame is generated the size of that image frame matches or is compatible with the size of the next increment in image frame size generated by the first image processing pipeline. This enables the super resolution image frames to be inserted into the animation sequence in block 508, replacing an image frame from the first image processing pipeline.

Thus, as illustrated in the arrow 510, as each super resolution image frame is generated by the second image processing pipeline, the image may be provided to the display generator of the computing device for use in the zoom animation generated in block 508. Additionally, the same super resolution image frame is provided to the first image processing pipeline, as illustrated in arrow 512, for use by the first image processing pipeline in generating the next larger image frame using the interpolation technique.

In block 508 the computing device will render on the display image frames as they are received from either the first image processing pipeline or the second image processing pipeline in order to produce a zoom animation on the display. By rendering image frames on the display as they are generated by the first image processing pipeline, a smooth animation can be produced in block 508. By substituting super resolution image frames generated by the second image processing pipeline in sequence, and the first image processing pipeline receiving and enlarging such super resolution image frames, the image quality of the animation produced in block 508 may be improved compared to enlargements accomplished using only the interpolation technique of the first image processing pipeline.

In determination block 514, the computing device may determine whether further user zoom inputs are being received, such as whether the user's finger tips are continuing to move across a touch sensitive display or a scroll bar is being moved by mouse input.

In response to further user zoom inputs being received (i.e., determination block 514=“Yes”), the computing device may repeat the operations of receiving the user zoom input in block 502, generating enlarged image frames in the first image processing pipeline in block 504, generating upscale super resolution image frames in the second image processing pipeline in block 506, and displaying image frames from either the first or second image processing pipelines to produce the zoom animation in block 508.

Once the user zoom input ends, such as the user stops touching the display or stops moving a scroll bar (i.e., determination block 514=“Yes”), the computing device may render the final image frame resulting from the zoom in block 516 by displaying a final output of the second image processing pipeline, illustrated by arrow 518. Displaying a final image generated using super resolution techniques of the second image processing pipeline yields a higher definition and quality image than would be possible using the interpolation techniques of the first image processing pipeline.

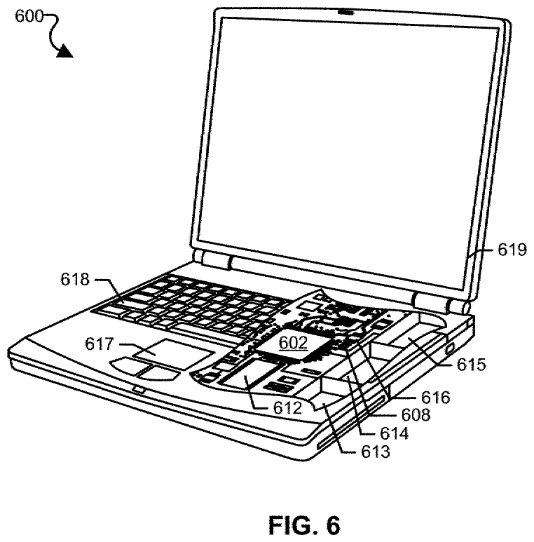

FIG. 6 illustrates a method 600 of performing a zoom operation on a display of a computing device in accordance with some embodiments. Method 600 may be performed by one or more processors (e.g., processors 410, 412, 414, 416, 418, 421, 422, 452, 460 illustrated in FIG. 4) in a computing device.

Various embodiments (including, but not limited to, embodiments described above with reference to FIGS. 1-5) may be implemented in a wide variety of wireless devices and computing systems include a laptop computer 600 including a Bluetooth transceiver, an example of which is illustrated in FIG. 6. With reference to FIGS. 1-6, a laptop computer may include a touchpad touch surface 617 that serves as the computer's pointing device, and thus may receive drag, scroll, and flick gestures similar to those implemented on computing devices equipped with a touch screen display and described above. A laptop computer 600 will typically include a processor 602 coupled to volatile memory 612 and a large capacity nonvolatile memory, such as a disk drive 613 of Flash memory. Additionally, the computer 600 may have one or more antenna 608 for sending and receiving electromagnetic radiation that may be connected to a wireless data link and/or cellular telephone transceiver 616 coupled to the processor 602. The computer 600 may also include a BT transceiver 614 implementing various embodiments. The computer 600 may also include a compact disc (CD) drive 615 coupled to the processor 602. The laptop computer 600 may include a touchpad 617, a keyboard 618, and a display 619 all coupled to the processor 602. Other configurations of the computing device may include a computer mouse or trackball coupled to the processor (e.g., via a Universal Serial Bus (USB) input) as are well known, which may also be used in conjunction with various embodiments.

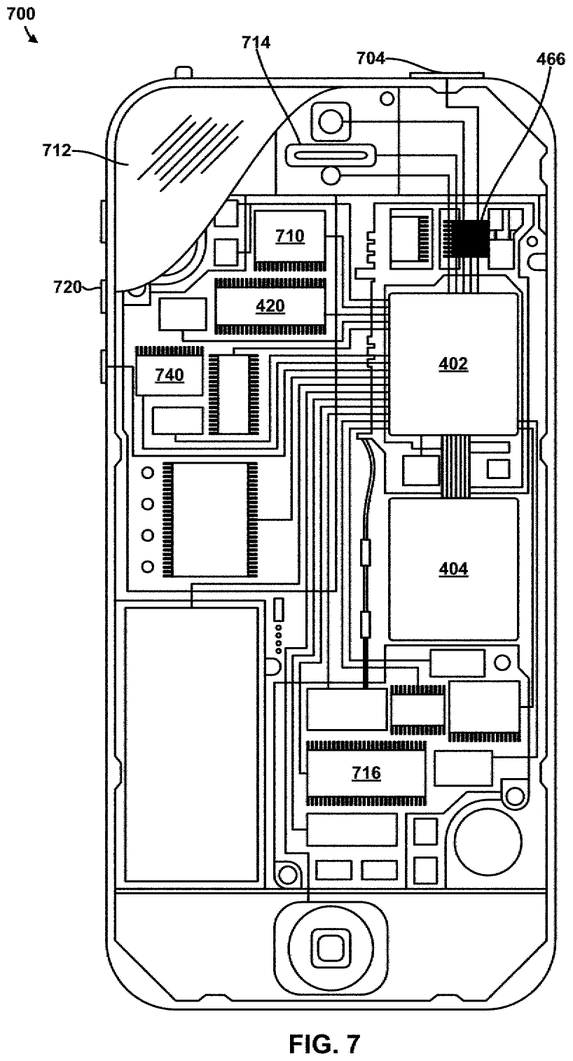

FIG. 7 is a component block diagram of a computing device 700 suitable for use with various embodiments. With reference to FIGS. 1-7, various embodiments may be implemented on a variety of computing devices 700 (e.g., 402, 404, 416, 400), an example of which is illustrated in FIG. 7 in the form of a smartphone. The computing device 700 may include a first circuitry 402 coupled to a second circuitry 404. The first and second SoCs 402, 404 may be coupled to internal memory 716, a display 712, and to a speaker 714. The first and second circuitries 402, 404 may also be coupled to at least one subscriber identity module (SIM) 740 and/or a SIM interface that may store information supporting a first 5GNR subscription and a second 5GNR subscription, which support service on a 5G non-standalone (NSA) network.

The computing device 700 may include an antenna 704 for sending and receiving electromagnetic radiation that may be connected to a wireless transceiver 466 coupled to one or more processors in the first and/or second circuitries 402, 404. The computing device 700 may also include menu selection buttons or rocker switches 720 for receiving user inputs.

The computing device 700 also includes a sound encoding/decoding (CODEC) circuit 710, which digitizes sound received from a microphone into data packets suitable for wireless transmission and decodes received sound data packets to generate analog signals that are provided to the speaker to generate sound. Also, one or more of the processors in the first and second circuitries 402, 404, wireless transceiver 466 and CODEC 710 may include a digital signal processor (DSP) circuit (not shown separately).

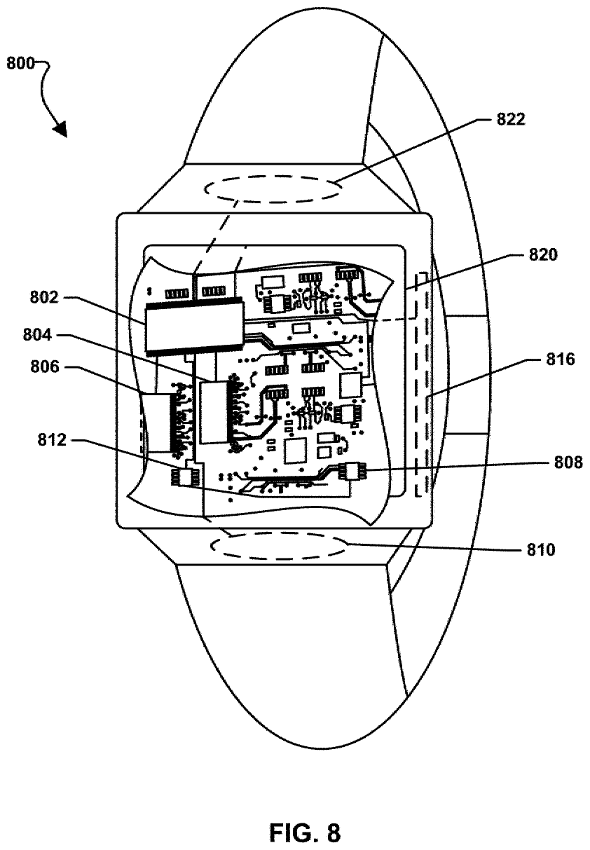

Various embodiments may be implemented within a variety of computing devices, such as a wearable computing device. FIG. 8 illustrates an example wearable computing device in the form of a smart watch 800 according to some embodiments. A smart watch 800 may include an SoC 802 including two or more processors (e.g., application processor, low power processor) coupled to internal memories 804 and 806. Internal memories 804, 806 may be volatile or non-volatile memories, and may also be secure and/or encrypted memories, or unsecure and/or unencrypted memories, or any combination thereof. The SoC 802 may also be coupled to a touchscreen display 820, such as a resistive-sensing touchscreen, capacitive-sensing touchscreen infrared sensing touchscreen, or the like. Additionally, the smart watch 800 may have one or more antenna 808 for sending and receiving electromagnetic radiation that may be connected to one or more wireless data links 812, such as one or more Bluetooth® transceivers that may be coupled to the SoC 802. The smart watch 800 may also include physical virtual buttons 822 and 810 for receiving user inputs as well as a slide sensor 816 for receiving user inputs.

The touchscreen display 820 may be coupled to a touchscreen interface module that is configured receive signals from the touchscreen display 820 indicative of locations on the screen where a user's fingertip or a stylus is touching the surface and output to the SoC 802 information regarding the coordinates of touch events. Further, the SoC 802 may be configured with processor-executable instructions to correlate images presented on the touchscreen display 820 with the location of touch events received from the touchscreen interface module in order to detect when a user has interacted with a graphical interface icon, such as a virtual button.

The SoC 802 may be any programmable microprocessor, microcomputer or multiple processor chip or chips that can be configured by software instructions (applications) to perform a variety of functions, including the functions of various embodiments. In some devices, multiple processors may be provided, such as one processor dedicated to wireless communication functions and one processor dedicated to running other applications. Typically, software applications may be stored in an internal memory before they are accessed and loaded into the SoC 802. The SoC 802 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 802 including internal memory or removable memory plugged into the wearable device and memory within the SoC 802 itself.

The processors of the computer 800, the computing device 700, and the smart watch 800 may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry 402 dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method of performing a zoom operation on a computing device, including receiving a zoom user input on an image layer within a display on the computing device, and rendering an animation of adjustments in a displayed size of the image layer, responsive to the received zoom user input, using image frames generated by a first image processing pipeline that uses an interpolation scaling technique to enlarge image frames of the image layer and image frames generated by a second image processing pipeline that uses a super resolution technique to upscale image frames of the image layer, in which the first image processing pipeline and the second image processing pipeline function in parallel, the second image processing pipeline outputs upscaled image frames of the image layer to the first image processing pipeline, and the first image processing pipeline uses the interpolation scaling technique to enlarge image upscaled frames received from the second image processing pipeline.

Example 2: The method of example 1, in which rendering the animation of adjustments in the displayed size of the image layer responsive to the received zoom user input begins with rendering of image frames generated by the first image processing pipeline based on the image layer until the first image processing pipeline receives an upscaled image frame from the second image processing pipeline, and continues thereafter rendering image frames generated by the first image processing pipeline based on the upscaled image frames received from the second image processing pipeline.

Example 3: The method of either of examples 1 or 2, in which the final rendering of the image layer after the zoom user input is complete is a final upscaled image generated by the second image processing pipeline.

Example 4: The method of any of examples 1-3, in which determining an upscaling ratio of super resolution image frames to interpolation scaled image frames based on the complexity of the super resolution technique and a power budget of the computing device, or tradeoffs between fast processing and higher quality output, and outputting the upscaled image frames from the second image processing pipeline at a rate compared to a rate at which image frames are generated by the first image processing pipeline based on the determined upscaling ratio.

Example 5: The method of any of examples 1-4, in which the interpolation scaling technique is performed in a graphics processing unit (GPU), and the super resolution technique is performed in a digital signals processor (DSP) or an artificial intelligence (AI) processor/accelerator.

Example 6: The method of any of examples 1-5, in which the second image processing pipeline uses an AI convolutional neural network (CNN) super resolution technique to upscale image frames of the image layer.

Example 7: The method of any of examples 1-4, in which the first image processing pipeline is a Bilinear-Bicubic pipeline, and the second image processing pipeline is a convolutional neural network super resolution (CNN SR) pipeline.

Example 8: The method of example 7, in which the Bilinear-Bicubic pipeline may be implemented in a GPU, deep processing unit (DPU), or concurrently on the GPU and DPU, and the CNN SR pipeline may be implemented in the GPU, DSP, central processing unit (CPU), or any combination thereof.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of performing a zoom operation on a computing device, comprising:
receiving a zoom user input on an image layer within a display on the computing device; and
rendering an animation of adjustments in a displayed size of the image layer, responsive to the received zoom user input, using image frames generated by a first image processing pipeline that uses an interpolation scaling technique to enlarge image frames of the image layer and image frames generated by a second image processing pipeline that uses a super resolution technique to upscale image frames of the image layer,
wherein:
the first image processing pipeline and the second image processing pipeline function in parallel;
the second image processing pipeline outputs upscaled image frames of the image layer to the first image processing pipeline; and
the first image processing pipeline uses the interpolation scaling technique to enlarge image upscaled frames received from the second image processing pipeline.

2. The method of claim 1, wherein rendering the animation of adjustments in the displayed size of the image layer responsive to the received zoom user input begins with rendering of image frames generated by the first image processing pipeline based on the image layer until the first image processing pipeline receives an upscaled image frame from the second image processing pipeline, and continues thereafter rendering image frames generated by the first image processing pipeline based on the upscaled image frames received from the second image processing pipeline.

3. The method of claim 1, wherein a final rendering of the image layer after the zoom user input is complete is a final upscaled image generated by the second image processing pipeline.

4. The method of claim 1, further comprising:
determining an upscaling ratio of super resolution image frames to interpolation scaled image frames based on:
complexity of the super resolution technique and a power budget of the computing device; or
tradeoffs between fast processing and higher quality output; and
outputting the upscaled image frames from the second image processing pipeline at a rate compared to a rate at which image frames are generated by the first image processing pipeline based on the determined upscaling ratio.

5. The method of claim 1, wherein:
the interpolation scaling technique is performed in a graphics processing unit (GPU); and
the super resolution technique is performed in a digital signals processor (DSP) or an artificial intelligence (AI) processor/accelerator.

6. The method of claim 1, wherein the second image processing pipeline uses an artificial intelligence (AI) convolutional neural network (CNN) super resolution technique to upscale image frames of the image layer.

7. The method of claim 1, wherein:
the first image processing pipeline is a Bilinear-Bicubic pipeline; and
the second image processing pipeline is a convolutional neural network super resolution (CNN SR) pipeline.

8. The method of claim 7, wherein:
the Bilinear-Bicubic pipeline is implemented in a graphics processing unit (GPU), deep processing unit (DPU), or concurrently on the GPU and DPU; and
the CNN SR pipeline is implemented in the GPU, a digital signals processor (DSP), a central processing unit (CPU), or any combination thereof.

9. A computing device, comprising:
a display; and
a processor coupled to the display and configured to:
receive a zoom user input on an image layer within the display; and
render an animation of adjustments in a displayed size of the image layer, responsive to the received zoom user input, using image frames generated by a first image processing pipeline that uses an interpolation scaling technique to enlarge image frames of the image layer and image frames generated by a second image processing pipeline that uses a super resolution technique to upscale image frames of the image layer,
wherein:
the first image processing pipeline and the second image processing pipeline function in parallel;
the second image processing pipeline outputs upscaled image frames of the image layer to the first image processing pipeline; and
the first image processing pipeline uses the interpolation scaling technique to enlarge image upscaled frames received from the second image processing pipeline.

10. The computing device of claim 9, wherein the processor is configured to render the animation of adjustments in the displayed size of the image layer responsive to the received zoom user input beginning with rendering of image frames generated by the first image processing pipeline based on the image layer until the first image processing pipeline receives an upscaled image frame from the second image processing pipeline, and continuing thereafter rendering image frames generated by the first image processing pipeline based on the upscaled image frames received from the second image processing pipeline.

11. The computing device of claim 9, wherein the processor is configured so that a final rendering of the image layer after the zoom user input is complete is a final upscaled image generated by the second image processing pipeline.

12. The computing device of claim 9, wherein the processor is configured to:
determine an upscaling ratio of super resolution image frames to interpolation scaled image frames based on:
complexity of the super resolution technique and a power budget of the computing device; or
tradeoffs between fast processing and higher quality output; and
output the upscaled image frames from the second image processing pipeline at a rate compared to a rate at which image frames are generated by the first image processing pipeline based on the determined upscaling ratio.

13. The computing device of claim 9, wherein the processor is configured so that:
the interpolation scaling technique is performed in a graphics processing unit (GPU); and
the super resolution technique is performed in a digital signals processor (DSP) or an artificial intelligence (AI) processor/accelerator.

14. The computing device of claim 9, wherein the processor is configured so that the second image processing pipeline uses an artificial intelligence (AI) convolutional neural network (CNN) super resolution technique to upscale image frames of the image layer.

15. The computing device of claim 9, wherein:
the first image processing pipeline is a Bilinear-Bicubic pipeline; and
the second image processing pipeline is a convolutional neural network super resolution (CNN SR) pipeline.

16. The computing device of claim 15, wherein:
the Bilinear-Bicubic pipeline is implemented in a graphics processing unit (GPU), deep processing unit (DPU), or concurrently on the GPU and DPU; and
the CNN SR pipeline is implemented in the GPU, a digital signals processor (DSP), a central processing unit (CPU), or any combination thereof.

17. A non-transitory computer readable storage medium having stored thereon processor-executable software instructions configured to cause a processor of a computing device to perform operations comprising:
receiving a zoom user input on an image layer within a display of the computing device; and
rendering an animation of adjustments in a displayed size of the image layer, responsive to the received zoom user input, using image frames generated by a first image processing pipeline that uses an interpolation scaling technique to enlarge image frames of the image layer and image frames generated by a second image processing pipeline that uses a super resolution technique to upscale image frames of the image layer,
wherein:
the first image processing pipeline and the second image processing pipeline function in parallel;
the second image processing pipeline outputs upscaled image frames of the image layer to the first image processing pipeline; and
the first image processing pipeline uses the interpolation scaling technique to enlarge image upscaled frames received from the second image processing pipeline.

18. The non-transitory computer readable storage medium of claim 17, wherein the stored processor-executable software instructions are configured to cause the processor to perform operations such that rendering the animation of adjustments in the displayed size of the image layer responsive to the received zoom user input begins with rendering of image frames generated by the first image processing pipeline based on the image layer until the first image processing pipeline receives an upscaled image frame from the second image processing pipeline, and continues thereafter rendering image frames generated by the first image processing pipeline based on the upscaled image frames received from the second image processing pipeline.

19. The non-transitory computer readable storage medium of claim 17, wherein the stored processor-executable software instructions are configured to cause the processor to perform operations such that a final rendering of the image layer after the zoom user input is complete is a final upscaled image generated by the second image processing pipeline.

20. The non-transitory computer readable storage medium of claim 17, wherein the stored processor-executable software instructions are configured to cause the processor to perform operations further comprising:
determining an upscaling ratio of super resolution image frames to interpolation scaled image frames based on:
complexity of the super resolution technique and a power budget of the computing device; or
tradeoffs between fast processing and higher quality output; and
outputting the upscaled image frames from the second image processing pipeline at a rate compared to a rate at which image frames are generated by the first image processing pipeline based on the determined upscaling ratio.

21.-30. (canceled)
